(19) United States
(12) Patent Application Publication
(10) Pub. No.: US 2022/0154752 A1
(43) Pub. Date: May 19, 2022

(54) SELF-ALIGNING CONNECTOR

(71) Applicant: Waterfall Industries, Inc. d/b/a Discovery World Furniture, Inc., Sanford, FL (US)

(72) Inventors: Anthony C. Lupo, Palm Coast, FL (US); Luiz H. Miranda, Sanford, FL (US)

(21) Appl. No.: 17/515,781

(22) Filed: Nov. 1, 2021

Related U.S. Application Data
(60) Provisional application No. 63/115,802, filed on Nov. 19, 2020.

(51) Int. Cl. F16B 12/56; A47C 19/02

(52) U.S. Cl. CPC F16B 12/56; A47C 19/022

(57) ABSTRACT

A self-aligning connector configured to connect a first connectable part to a second connectable part. The connector comprises a body member, a fastening member, and an alignment member. The body member has an inner surface configured to face the underlying first connectable part. The fastening member that extends from a first surface portion of the body member. The fastening member includes a fastening aperture that extends through the fastening member and is configured to receive a fastening anchor. The alignment member extends from a second surface portion of the body member and is spaced from the fastening member along a surface of the body member.

### CROSS-REFERENCE TO RELATED APPLICATIONS

This application claims priority to U.S. Provisional Application No. 63/115,802, filed Nov. 19, 2020, entitled “Self-Aligning Connector” the content of which is hereby incorporated by reference in its entirety.

### TECHNICAL FIELD

This disclosure relates generally to a self-aligning connector and, more particularly, a connector configured to self-align to receive a corresponding fastening member.

### BACKGROUND

Connectors and fasteners are commonly used to join two parts or pieces together, such as cabinets, bookcases, beds, or other fixtures. An example of a connector and fastener combination includes a nut and a bolt. The nut generally includes an internally threaded aperture, and the bolt includes an externally threaded surface that corresponds to the internally threaded nut. To assemble a fixture, the bolt can be inserted within, about, and/or through two or more fixtures and connected to the nut. The nut and bolt combination can be rotatably tightened to secure the two or more fixtures together.

In certain instances, the nut is required to be positioned between one or more fixtures and/or positioned within a fixture in order to join the fixtures together. The aperture of the nut not only has to be aligned with the bolt to connect the bolt to the nut, but also may be required to align with pre-drilled holes in the connectable part. The alignment typically occurs by rotational, horizontal, and vertical adjustments of the nut. The adjustments can be facilitated by features of the nut (e.g. recesses/protrusions), shape/size of the nut, through the use of tools, or combinations thereof. However, the alignment can be time consuming, especially when the connectable part requires multiple fastening assemblies and additional tools specific to the configuration of the nut.

The foregoing background discussion is intended solely to aid the reader. It is not intended to limit the innovations described herein. Thus, the foregoing discussion should not be taken to indicate that any particular element of a prior system is unsuitable for use with the innovations described herein, nor is it intended to indicate that any element is essential in implementing the innovations described herein.

### SUMMARY

The foregoing needs are met, to a great extent, by the connector disclosed in the present application. The connector is configured to self-align with pre-drilled holes in a connectable part (e.g. a furniture part) to securely and efficiently enable the connectable part to be joined to one or more other connectable parts. The connector includes at least one receiving aperture configured to receive a fastening anchor. When the connector is inserted into a first pre-drilled hole in the connectable part, the receiving aperture self-aligns with a second pre-drilled hole of the connectable part. The alignment is facilitated by an alignment member of the connector, as further described herein. The connectable parts can then be joined together by inserting a fastening anchor through the second pre-drilled hole of the connectable part and into the receiving aperture of the self-aligned connector. The fastening anchor can be secured to the connector to firmly join the connectable parts.

The benefits of the connector disclosed in the present application include, for example, a more stable and stronger connection than many conventional connectors, a more simplified manufacturing process, and if pre-installed, a more simplified installation of the connector during the manufacturing process. The connector can be installed in smaller holes than many conventional connectors allowing less material to be removed from the connectable part thereby increasing the strength of the connectable part. During production, no special milling is required at the end of the connectable part. Common industry boring operations can be performed to produce the pre-drilled holes. For the end consumer, assembly is less cumbersome because the connector is self-aligned and retained. Use of the connector dramatically reduces both the assembly time and the amount of hardware that the consumer needs for the assembly of an item by as much as 50%. For example, conventional connector assembly packs can include several tiny parts that require either or both assembly and alignment during manufacture. The connector described herein simplifies the hardware pack provided to the customer which reduces the time required for assembly and alignment, and the customer has the ability to easily change the connector if there is, for example, a cross-thread or defect.

An aspect of the present disclosure provides a self-aligning connector. The connector comprises a body member, a fastening member, and an alignment member. The body member has an inner surface configured to face an underlying connectable part. The inner surface has a first surface portion and a second surface portion. The first surface portion extends from a first end of the body member to the second surface portion, and the second surface portion extends from the first surface portion to a second end of the body member that is spaced from the first end of the body member. The fastening member extends from the first surface portion. The fastening member includes a fastening aperture that extends through the fastening member and is configured to receive a fastening anchor. The alignment member extends from the second surface portion and spaced from the fastening member along the surface of the body member.

An alternative aspect of the present disclosure provides a self-aligning connector system. The connector system comprises a connectable part and a connector. The connectable part has a part surface that defines a first receiving aperture and a second receiving aperture spaced from the first receiving aperture. The first and second receiving apertures extend at least partially through the connectable part. The connector comprises a connector body, a fastening member, and an alignment member. The connector body has an inner surface configured to face the part surface of the connectable part. The inner surface has a first surface portion and a second surface portion adjacent to the first surface portion. The fastening member extends from the first surface portion. The fastening member includes a fastening aperture that extends through the fastening member and is configured to receive a fastening anchor. The fastening member is positionable within the first receiving aperture of the connectable part. The alignment member extends from the second surface portion and spaced from the fastening member along the surface of the connector body. The alignment member is positionable within the second receiving aperture of the connectable part.

Another aspect of the present disclosure provides a method of manufacturing the connector system. The method comprises: inserting the fastening member into the first receiving aperture of the connectable part, wherein the fastening aperture opens to a third receiving aperture defined by the connectable part, the third receiving aperture extending at least partially through the connectable part and intersecting with the first receiving aperture; and inserting the alignment member within the second receiving aperture of the connectable part.

After the steps of inserting the fastening member and inserting the alignment member the inner surface of the connector body faces the part surface of the connectable part.

This summary is provided to introduce a selection of concepts in a simplified form that are further described below in the Detailed Description section. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there are shown in the drawings illustrative embodiments of the disclosure. It should be understood, however, that the application is not limited to the precise arrangements and instrumentalities shown. In the drawings:

FIG. 1A illustrates a top transparent perspective view of a connector system, according to an aspect of this disclosure.

FIG. 1B illustrates a top transparent perspective view of a close-up of the connector system shown in FIG. 1A taken about circle A.

FIG. 2A illustrates a top perspective view of a connector, according to an aspect of this disclosure.

FIG. 2B illustrates a top perspective view of a connector, according to an alternative aspect of this disclosure.

FIG. 2C illustrates a top perspective view of a connector, according to an alternative aspect of this disclosure.

FIG. 2D illustrates a top side view of the connector shown in FIG. 2C.

FIG. 3 illustrates a bottom perspective view of the connector shown in FIG. 2A.

FIG. 4 illustrates a front side view of the connector shown in FIG. 2A.

FIG. 5 illustrates a top side view of the connector shown in FIG. 2A.

FIG. 6 illustrates an exploded perspective view of a connector system, according to an aspect of this disclosure.

FIG. 7A illustrates a top perspective view of a connector, according to an alternative aspect of this disclosure.

FIG. 7B illustrates a top perspective view of a connector, according to an alternative aspect of this disclosure.

FIG. 8 illustrates a bottom perspective view of the connector shown in FIG. 7A.

FIG. 9 illustrates a front side view of the connector shown in FIG. 7A.

FIG. 10 illustrates a top side view of the connector shown in FIG. 7A.

FIG. 11 illustrates an exploded perspective view of a connector system, according to an alternative aspect of this disclosure.

FIG. 12A illustrates a top perspective view of a connector, according to another alternative aspect of this disclosure.

FIG. 12B illustrates a top perspective view of a connector, according to an alternative aspect of this disclosure.

FIG. 13 illustrates a bottom perspective view of the connector shown in FIG. 12A.

FIG. 14 illustrates a front side view of the connector shown in FIG. 12A.

FIG. 15 illustrates a top side view of the connector shown in FIG. 12A.

FIG. 16 illustrates a bottom side view of the connector shown in FIG. 12A.

FIG. 17 illustrates an exploded perspective view of a connector system, according to another alternative aspect of this disclosure.

FIG. 18 illustrates another exploded perspective view of the connector system shown in FIG. 17.

FIG. 19 illustrates another exploded perspective view of the connector system shown in FIG. 17.

FIG. 20 illustrates a side perspective view of a connector, according to another alternative aspect of this disclosure.

FIG. 21 illustrates a bottom perspective view of a connector, according to another alternative aspect of this disclosure.

FIG. 22A illustrates a top perspective view of a connector, according to another alternative aspect of this disclosure.

FIG. 22B illustrates a side perspective view of the connector shown in FIG. 22A.

FIG. 22C illustrates a front side view of the connector shown in FIG. 22A.

FIG. 23A illustrates a first side perspective view of a connector, according to another alternative aspect of this disclosure.

FIG. 23B illustrates a second side perspective view of the connector shown in FIG. 23A.

FIG. 23C illustrates a front side view of the connector shown in FIG. 23A.

FIG. 24 illustrates a top perspective view of a connector, according to another alternative aspect of this disclosure.

FIG. 25A illustrates a bottom perspective view of a connector, according to another alternative aspect of this disclosure.

FIG. 25B illustrates a top perspective view of the connector shown in FIG. 25A.

FIG. 26A illustrates a bottom perspective view of a connector, according to another alternative aspect of this disclosure.

FIG. 26B illustrates a top perspective view of the connector shown in FIG. 25A.

FIG. 27A illustrates a top perspective view of a multi-fastening connector, according to another alternative aspect of this disclosure.

FIG. 27B illustrates a side view of the connector shown in FIG. 27A.

FIG. 27C illustrates a front side view of the connector shown in FIG. 27A.

### DETAILED DESCRIPTION

Certain terminology used in this description is for convenience only and is not limiting. The words “axial”, “radial”, “circumferential”, “outward”, “inward”, “upper,” and “lower” designate directions in the drawings to which reference is made. As used herein, the term “substantially” and derivatives thereof, and words of similar import, when used to describe a size, shape, orientation, distance, spatial relationship, or other parameter includes the stated size, shape, orientation, distance, spatial relationship, or other parameter, and can also include a range up to 10% more and up to 10% less than the stated parameter, including 5% more and 5% less, including 3% more and 3% less, including 1% more and 1% less. All ranges disclosed herein are inclusive of the recited endpoint and independently combinable (for example, the range of “from 2 grams to 10 grams” is inclusive of the endpoints, 2 grams and 10 grams, and all the intermediate values). The terminology includes the above-listed words, derivatives thereof and words of similar import.

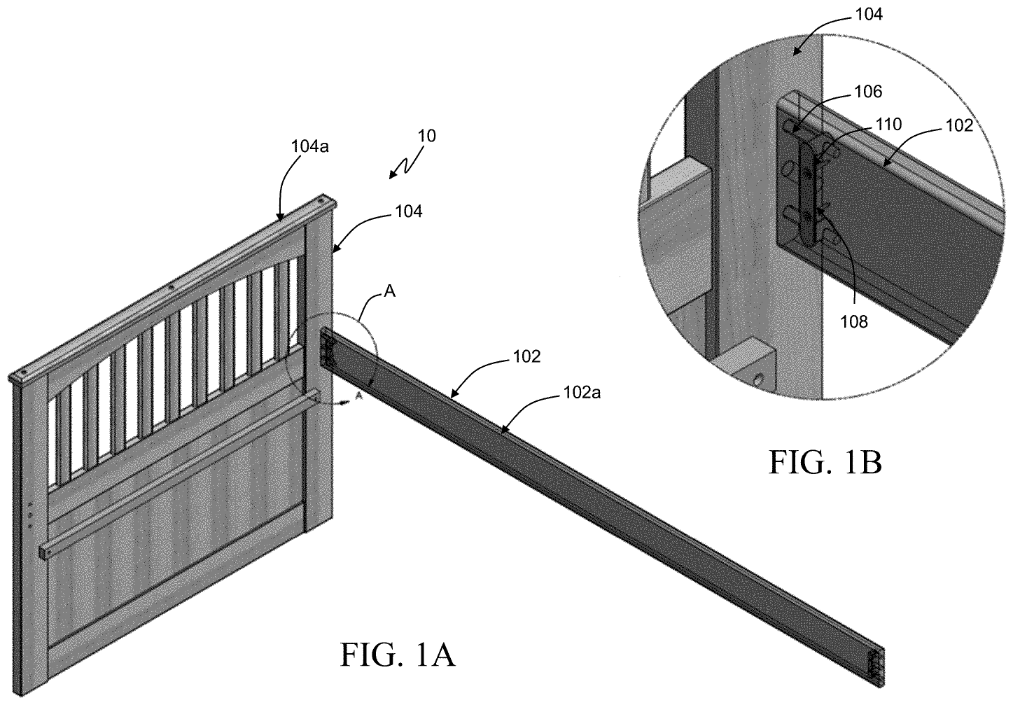

FIG. 1A illustrates a top transparent perspective view of a connector system 10, according to an aspect of this disclosure, and FIG. 1B illustrates a top transparent perspective view of a close-up of the connector system 10 taken about circle A shown in FIG. 1A. The connector system 10 includes a first connectable part 102, a second connectable part 104, one or more fastening anchors 106 (e.g. bolts, screws, pins, keys, or other types of fasteners), one or more fixation anchors 108, and a connector 110. The one or more fixation anchors 108 can secure the connector 110 to the first connectable part 102 and the one or more fastening anchors 106 can connect to the connector 110 to join the first and second connectable parts 102 and 104, as further described below. As illustrated, the first and second connectable parts 102 and 104 include a beam 102a and a bed frame 104a. It will be appreciated that the first and second connectable parts 102 and 104 can include other furniture parts such as, for example, cabinets, bookcases, beds, or other furniture parts, or still other types of connectable parts or fixtures.

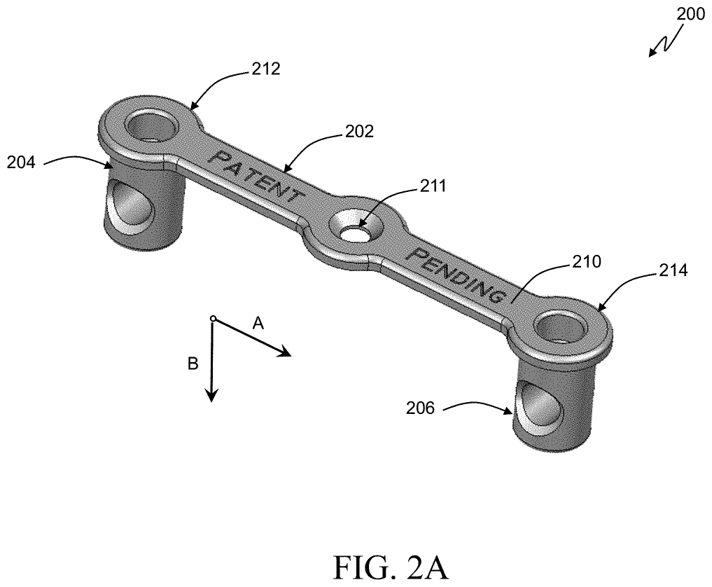

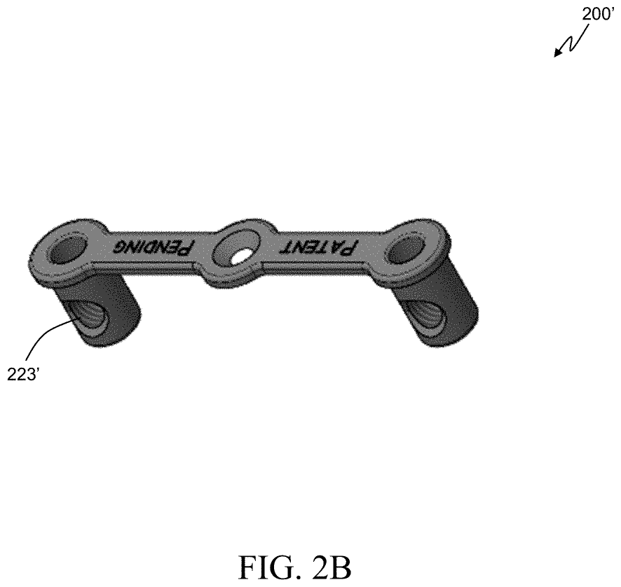

FIGS. 2 and 3 illustrate a top perspective view and a bottom perspective view, respectively, of an alternative aspect of a connector 200. It will be appreciated that the connector 110 can be positioned, aligned, and configured in a substantially similar manner as the connector 200 as described herein. The connector 200 includes a body member 202, a first fastening member 204, and a second fastening member 206. The body member 202 and the first and second fastening members 204 and 206 can be integrally formed as a single unitary piece. The body member 202 and the first and second fastening members 204 and 206 can be formed by, for example, casting, injection molding, stamping, computer numerical control (CNC) machining, 3D printing, or other type of manufacturing method. The connector 200 can comprise steel, titanium, plastic, or other type of material known in the art.

The body member 202 has an inner surface 208 and an opposing outer surface 210. In an aspect, the inner and outer surfaces 208 and 210 are substantially parallel and have a distance between them that forms the body member 202 in a shape of a flat beam or a plate (e.g. has a width greater than a thickness). The inner surface 208 extends from a first end 212 of the body member 202 to a second end 214 of the body member 202 in an axial direction A. The inner surface 208 is configured to face the underlying first connectable part 102. In an aspect, the inner surface 208 is configured to abut against a surface of the first connectable part 102 such that the inner surface 208 is substantially flush against the surface of the first connectable part 102.

The inner surface 208 includes a first surface portion 208a and a second surface portion 208b. The first surface portion 208a extends from the first end 212 of the body member 202 to the second surface portion 208b. The second surface portion 208b extends from the first surface portion 208a to the second end 214 of the inner surface 208. In an aspect, the first surface portion 208a extends from the first end 212 to a location at a center of the body member 202 between the first and second ends 212 and 214 in the axial direction A.

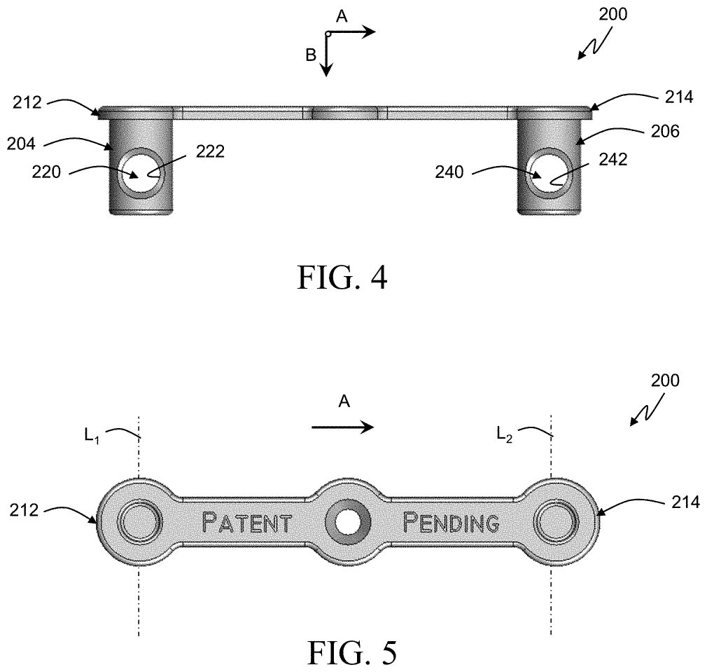

The first fastening member 204 extends from the first surface portion 208a. The first fastening member 204 includes an outer fastening surface 216 that extends about the fastening member 204 from the first surface portion 208a to an end 218 of the first fastening member 204. The outer fastening surface 216 can extend substantially cylindrically about the first fastening member 204 to define a first fastening member 204 that has a substantially cylindrical cross section. It will be appreciated that the outer fastening surface 216 can define the first fastening member 204 having a cross section that is rectangular, oval, hexagonal, combinations thereof or other shape or configuration. The first fastening member 204 is configured to be received within a first receiving aperture 120 of the first connectable part 102 (see FIG. 6). In an aspect, the shape and/or configuration of the first fastening member 204 corresponds to a shape and/or configuration of the first receiving aperture 120 of the first connectable part 102.

The outer fastening surface 216 extends from the first surface portion 208a in a fastening direction B. In an aspect, the fastening direction B is substantially perpendicular to the first surface portion 208a. In alternative aspects, the fastening direction B can extend at other angles from the first surface portion 208a. For example, the fastening direction B can correspond to an angle of an inner surface defining the first receiving aperture 120 of the first connectable part 102. If the inner surface of the first receiving aperture 120 is substantially perpendicular to an outer surface 126 of the first connectable part 102, then the fastening direction B can be substantially perpendicular to the first surface portion 208a such that the first fastening member 204 can be inserted into the first receiving aperture 120 and the inner surface 208 of the connector 200 can abut against the outer surface 126 of the first connectable part 102. Alternatively, if the inner surface of the first receiving aperture 120 is at an angle other than substantially perpendicular to the outer surface 126 of the first connectable part 102, then the fastening direction B can align with the other angle of the first receiving aperture 120 such that the first fastening member 204 can be inserted into the first receiving aperture 120 and the inner surface 208 of the connector 200 can abut against the outer surface 126 of the first connectable part 102. In an aspect, a central axis of the first fastening member 204 can align with a central axis of the first receiving aperture 120. The central axis of the first fastening member 204 can extend through a center of the first fastening member 204 in the fastening direction B, and the central axis of the first receiving aperture 120 can extend through a center of the first receiving aperture 120.

The first fastening member 204 includes a first fastening aperture 220 that extends through the first fastening member 204 from a first location on the outer fastening surface 216 to a second location on the outer fastening surface 216. The first fastening aperture 220 is defined by a first inner fastening surface 222. The first inner fastening surface 222 extends about a first aperture axis L₁ that extends through the first fastening member 204. The first inner fastening surface 222 can define a substantially cylindrical shape. The first inner fastening surface 222 is configured to receive a first fastening anchor 106a within. In an aspect, the first inner fastening surface 222 can include a threaded portion 223′ (see e.g. FIG. 2B; connector 200′). The threaded portion 223′ can extend about the first inner fastening surface 222 at least partially between the first location on the outer fastening surface 216 to the second location on the outer fastening surface 216. The threaded portion 223′ of the first inner fastening surface 222 is configured to threadedly engage a corresponding threaded portion of the first fastening anchor 106a. In an alternative aspect, the first inner fastening surface 222 can be free of a threaded portion such that the first inner fastening surface 222 is substantially smooth.

The second fastening member 206 can be configured substantially similarly to the first fastening member 204 such that portions of the second fastening member 206 function similarly to those described above with respect to the first fastening member 204. The second fastening member 206 can be spaced from the first fastening member 204 in the axial direction A. In an aspect, the second fastening member 206 can be spaced from the first fastening member 204 by a length of approximately 1 inch on center (OC). In alternative aspect, the second fastening member 206 can be spaced from the first fastening member 204 by a length of approximately 32 mm OC. It will be appreciated that the second fastening member 206 can be spaced from the first fastening member 204 by different lengths, such that the first and second fastening members 204 and 206 are receivable within the respective first and second receiving apertures 120 and 128 of the first connectable part 102.

The second fastening member 206 extends from the second surface portion 208b. The second fastening member 208b includes an outer fastening surface 236 that defines a shape of the second fastening member 206. In an aspect, the shape of the second fastening member 206 is substantially similar to the shape of the first fastening member 204. The second fastening member 206 is configured to be received within the second receiving aperture 128 of the first connectable part 102 (see FIG. 6). In an aspect, the shape and/or configuration of the second fastening member 206 corresponds to a shape and/or configuration of the second receiving aperture 128 of the first connectable part 102. It will be appreciated that the second fastening member 206 can have a shape that is different than the shape of the first fastening member 204. For example, if the second receiving aperture 128 has a shape or size that is different than a shape or size of the first receiving aperture 120, the second fastening member 206 can have a configuration such that the second fastening member 206 is positionable within the second receiving aperture 128, while the first fastening member 204 can have a configuration such that the first fastening member 204 is positionable within the first receiving aperture 120.

The second fastening member 206 includes a second fastening aperture 240 that extends through the second fastening member 206. The second fastening aperture 240 is defined by a second inner fastening surface 242. The second inner fastening surface 242 extends about a second aperture axis L₂ that extends through the second fastening member 206. The second inner fastening surface 242 is configured to receive a second fastening anchor 106b within. In an aspect, the second inner fastening surface 242 can include a threaded portion that extends about the second inner fastening surface 242. The threaded portion of the second inner fastening surface 242 is configured to threadedly engage a corresponding threaded portion of the second fastening anchor 106b. In an alternative aspect, the second inner fastening surface 242 can be free of a threaded portion such that the second inner fastening surface 242 is substantially smooth.

The first and second aperture axes L₁ and L₂ of the respective first and second fastening apertures 220 and 240 are configured to align with respective third and fourth receiving apertures 122 and 130 defined by the first connectable part 102. The third receiving aperture 122 extends through the outer surface 126 and extends at least partially through the connectable part 102, and intersects with the first receiving aperture 120 within the first connectable part 102. The third receiving aperture 122 extends about a third aperture axis L₃. The fourth receiving aperture 130 extends through the outer surface 126 and extends at least partially through the connectable part 102, and intersects with the second receiving aperture 128 within the first connectable part 102. The fourth receiving aperture 130 extends about a fourth aperture axis L₄. The outer surface 126 can include a first outer surface 126a (e.g. first part surface) and a second outer surface (not visible in the figures) (e.g. second part surface). The first and second receiving apertures 120 and 128 extend through the first outer surface 126a, and the third and fourth receiving apertures 122 and 130 extend through the second outer surface. In an aspect, the first outer surface 126a is substantially perpendicular to the second outer surface. It will be appreciated that the first outer surface 126a and the second outer surface can be angularly offset from one another at angles other than 90 degrees. When the connector 200 is positioned on the first connectable part 102, the first and second aperture axes L₁ and L₂ of the respective first and second fastening members 204 and 204 can be aligned and/or colinear with the respective third and fourth aperture axes L₃ and L₄ of the first connectable part 102. In an aspect, the first, second, third, and fourth receiving apertures 120, 128, 122, and 130 can comprise pre-drilled holes.

The first and second aperture axes L₁ and L₂ of the respective first and second fastening apertures 220 and 240 can extend at an angle offset from the fastening direction B at which the first and second fastening members 204 and 204 extend. In an aspect, the first and second aperture axes L₁ and L₂ are substantially perpendicular to the fastening direction B.

The body member 202 can include a fixation aperture 211 that extends through the body member 202 from the outer surface 210 to the inner surface 208. It will be appreciated that the fixation aperture 211 is optional. For example, the body member 202 may not include a fixation aperture or any aperture extending therethrough (see e.g. FIGS. 2C and 2D; connector 200″ including body member 202″). The fixation aperture 211 is configured to receive a fixation anchor 140 therein (see FIG. 6). The fixation anchor 140 can include, for example, a set screw, a wood screw, or other types of fasteners known in the art. The fixation anchor 140 is configured to retain the connector 200 in position on the first connectable part 102 so that the first and second fastening anchors 106a and 106b can be inserted into the respective first and second fastening apertures 220 and 240 The fixation anchor 140 can also ensure that the connector 200 stays in place during shipping if the connector 200 has been pre-installed in the first connectable part 102. It will be appreciated that the body member 202 can include more than one fixation aperture 211 spaced along the body member 202 between the first and second ends 212 and 214. In an aspect, the fixation aperture 211 is located in a center of the body member 202 between the first and second ends 212 and 214.

The first surface portion 208a and the second surface portion 208b of the body member 202 can extend relative to one another to define a substantially flat inner surface 208 from the first end 212 to the second end 214. For example, an angle between the first surface portion 208a and the second surface portion 208b can be approximately 180 degrees. In an alternative aspect, the first surface portion 208a can be angularly offset from the second surface portion 208b. For example, the angle between the first surface portion 208a and the second surface portion 208b can be less than or greater than 180 degrees. In an aspect, the first surface portion 208a and the second surface portion 208b define an inner surface 208 having an approximate L-shape. For example, the angle between the first surface portion 208a and the second surface portion 208b can be approximately 270 degrees. In another example, the L-shaped inner surface 208 can be defined by an angular offset between the first surface portion 208a and the second surface portion 208b of approximately 90 degrees. It will be appreciated that the angle between the first surface portion 208a and the second surface portion 208b can correspond to an angle between the first and second receiving apertures 120 and 128 of the first connectable part 102. For example, if the first and third receiving apertures 120 and 128 open in directions that are approximately 90 degrees apart, the angle between the first surface portion 208a and the second surface portion 208b can be approximately 270 degrees such that the first and second fastening members 204 and 206 align with the first and second receiving apertures 120 and 128 of the first connectable part 102.

The precise appearance and structure defined by the connector 200 may be modified without departing from the scope of the present disclosure. For example, the connector 200 may include a single fastening member 204 and an alignment member, as further described below. In another alternative, the connector could have more than two fastening members 204 and 206 configured to be received within corresponding receiving apertures of the first connectable part 102.

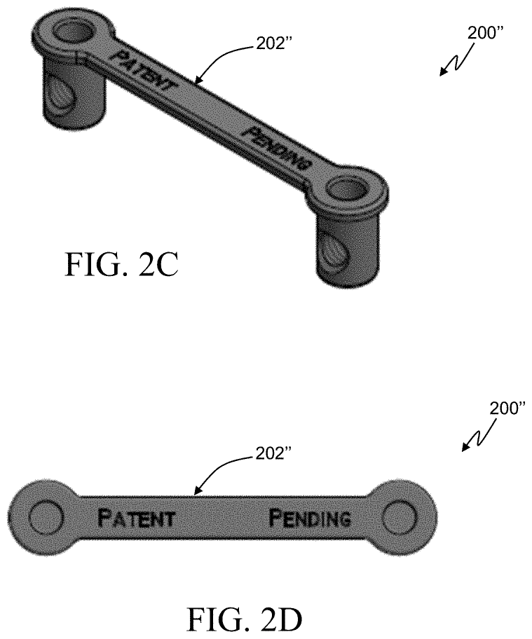

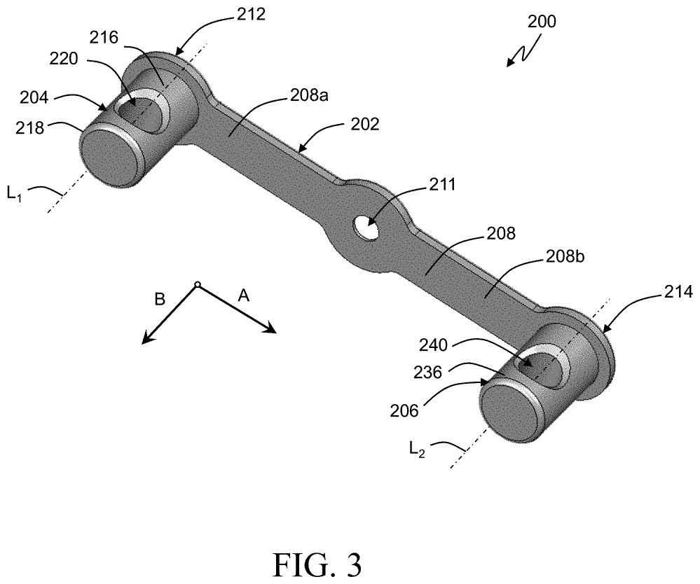

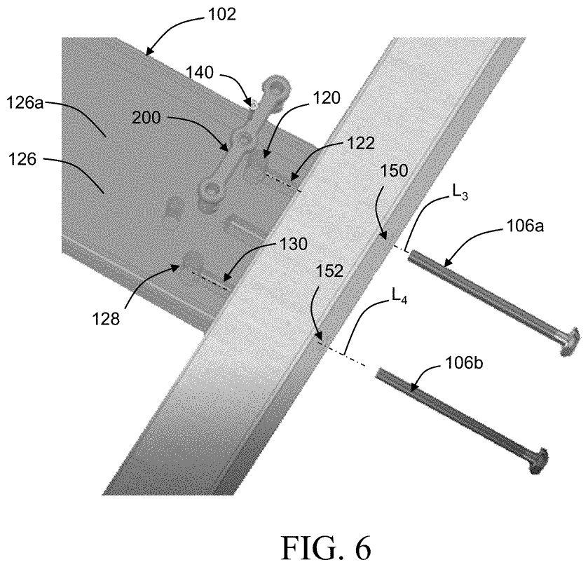

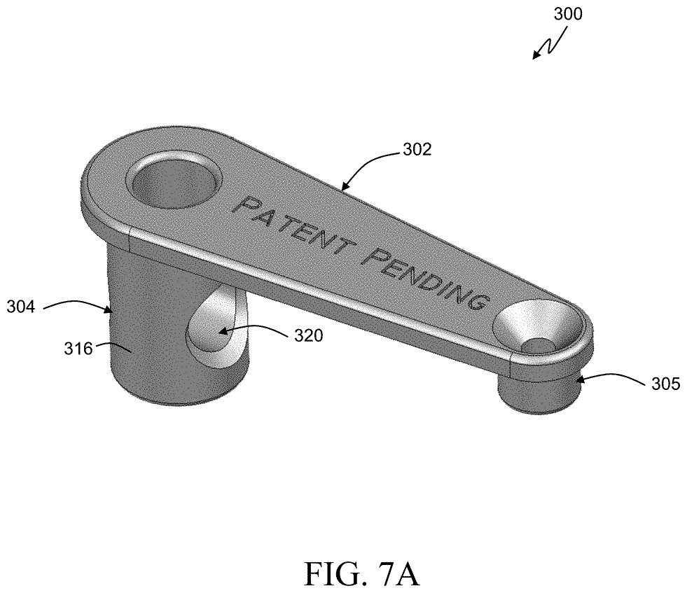

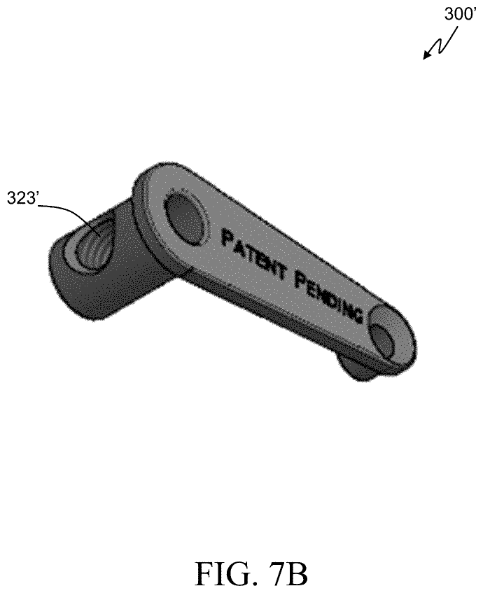

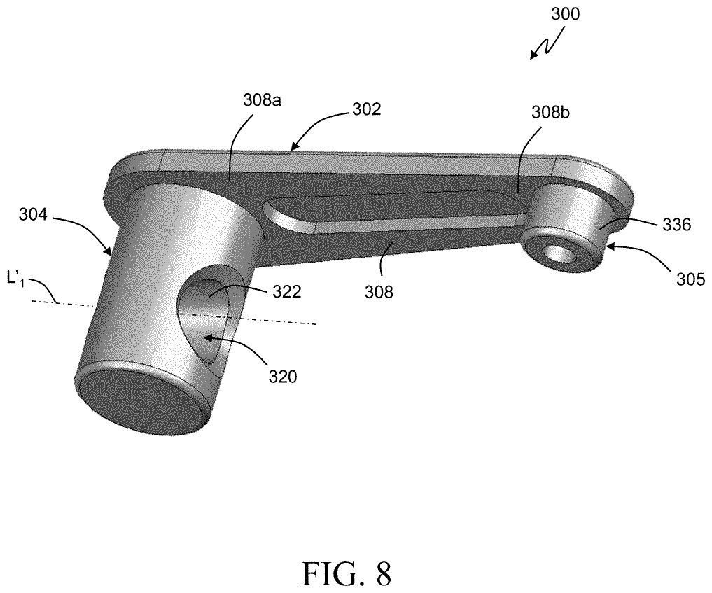

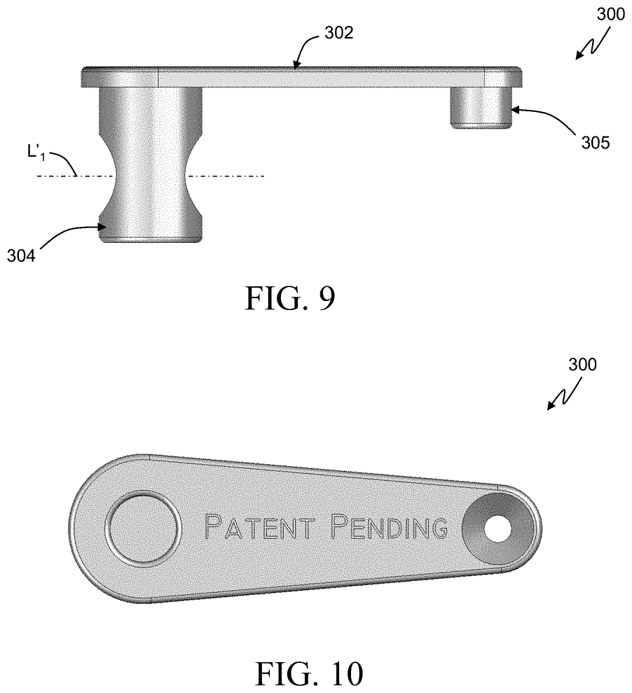

FIGS. 7 through 11 illustrate an alternate aspect of a connector 300. Portions of the embodiment disclosed in FIGS. 6 through 11 are similar to aspects described above in FIGS. 1 through 5 and those portions function similarly to those described above. The connector 300 is a single fastening connector that includes a body member 302, a first fastening member 304, and an alignment member 305. The connector 300 is configured to be inserted into a first connectable part 102′ and receive a first fastening anchor 106′ within to join the first connectable part 102′ to a second connectable part 104′ (see FIG. 11).

The first fastening member 304 extends from first surface portion 308a of an inner surface 308 of the body member 302. The first fastening member 304 includes an outer fastening surface 316 that extends about the fastening member 304. The first fastening member 304 is configured to be received within a first receiving aperture 120′ defined by the first connectable part 102′. The first fastening member 304 includes a first fastening aperture 320 that extends through the first fastening member 304 from a first location on the outer fastening surface 316 to a second location on the outer fastening surface 316. The first fastening aperture 320 is defined by a first inner fastening surface 322 that extends about a first aperture axis L′₁ that extends through the first fastening member 304. The first inner fastening surface 322 can be unthreaded, or alternatively, the first inner fastening surface 322 can include a threaded portion 323′ (see e.g. FIG. 7B, connector 300′).

The alignment member 305 extends from a second surface portion 308b of the inner surface 308 of the body member 302. The alignment member 305 includes an outer alignment surface 336 that defines a shape of the alignment member 305. The alignment member 305 is configured to be received within an alignment aperture 121 (see FIG. 11) of the first connectable part 102. In an aspect, the shape and/or configuration of the alignment member 305 corresponds to a shape and/or configuration of the alignment aperture 121 of the first connectable part 102′. For example, the alignment aperture 121 can have a shape that is, for example, round, slotted, grooved, oval, square, triangular, or other shapes, and the alignment member 305 can have a corresponding shape so that the alignment member 305 can be inserted into the alignment aperture 121. The alignment aperture 121 can extend either wholly through the first connectable part 102′, or alternatively, the alignment aperture 121 can extend partially through the first connectable part 102′ such that the alignment aperture 121 forms a recess-like shape/formation in the first connectable part 102. In an aspect, the outer alignment surface 336 is substantially perpendicular to the second surface portion 308b.

The alignment member 305 can have a shape and/or size that is different than the shape and/or size of the first fastening member 304. An alignment member 305 that has a shape and/or size that is different than the shape and/or size of the first fastening member 304 can facilitate insertion of the connector 300 into the first receiving aperture 120′ and the alignment aperture 121 such that the connector 305 can be inserted into the first connectable part 102′ in a specific orientation. For example, the first fastening member 304 and the alignment member 305 can be configured such that they can only be inserted into the first connectable part 102′ in the specific orientation. The specific orientation of the connector 300 within the first connectable part 102′ aligns the first fastening aperture 320 of the first fastening member 304 with a third receiving aperture 122′ of the first connectable part 102′. In an aspect, when the connector 300 is positioned within the first connectable part 102′ the first aperture axis L′₁ of the first fastening member 304 can be aligned with (e.g. colinear) with a third aperture axis first aperture axis L′₃ of the first connectable part 102′. It will be appreciated that the alignment member 305 can include an aperture, multiple apertures, or be formed with a solid continuous outer surface free of any apertures.

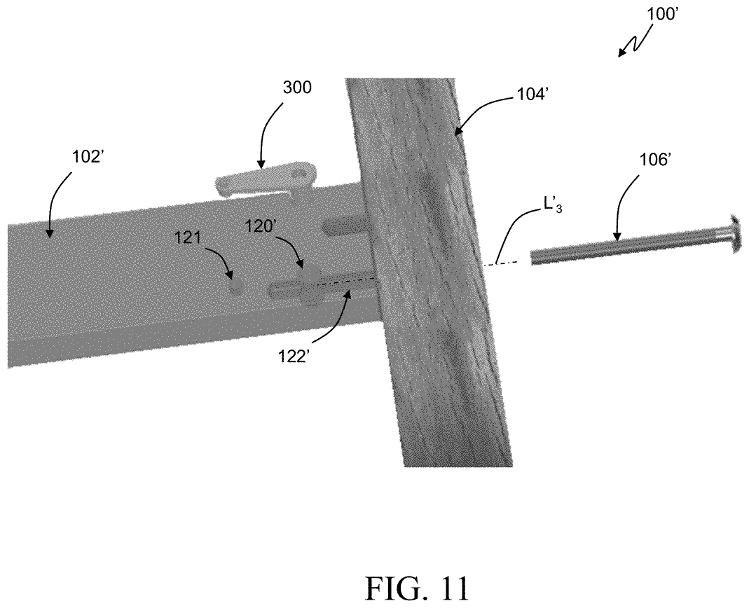

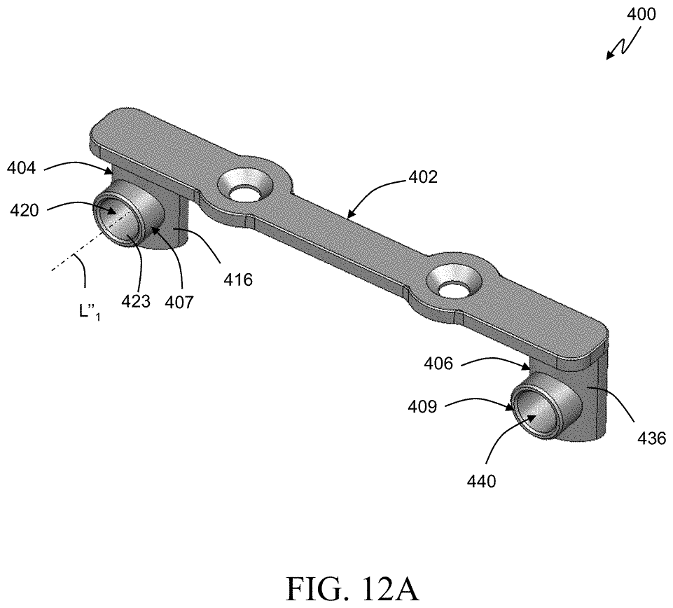

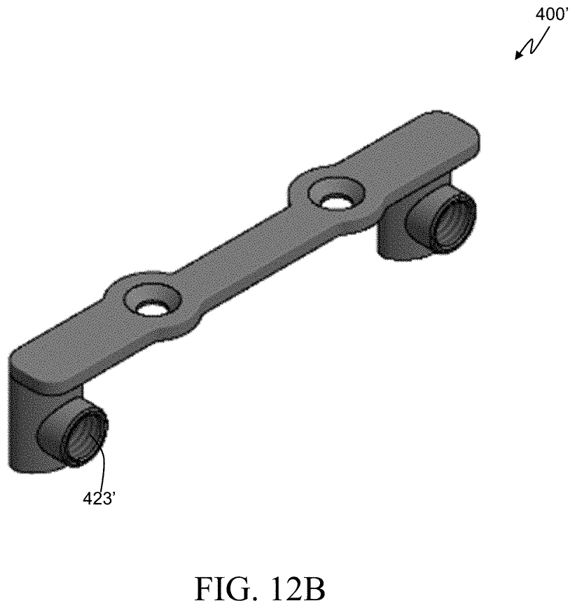

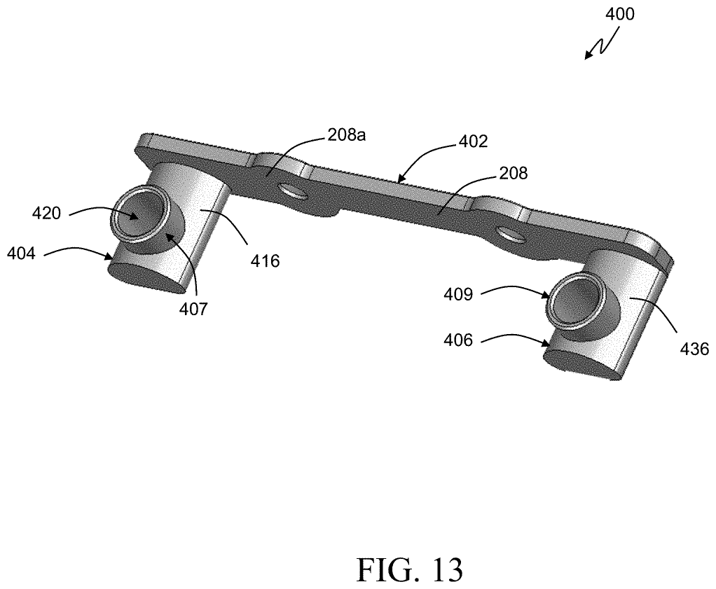

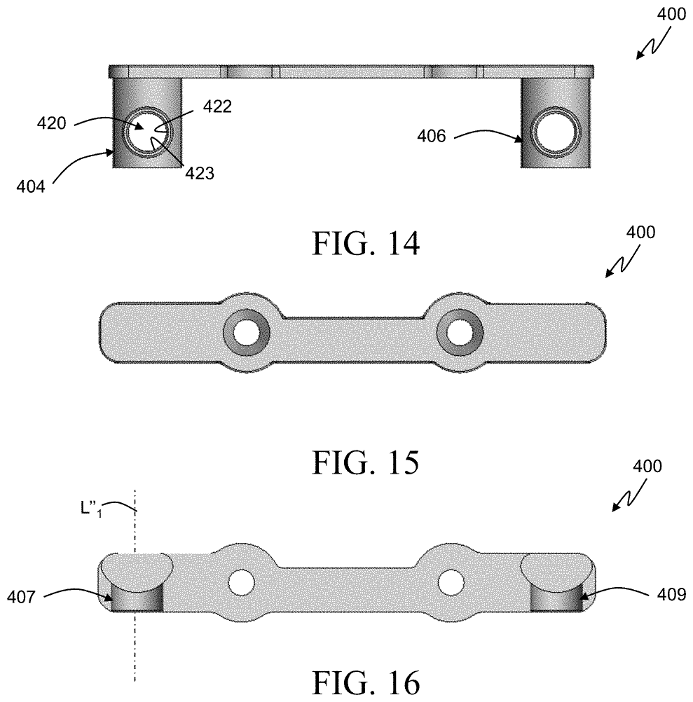

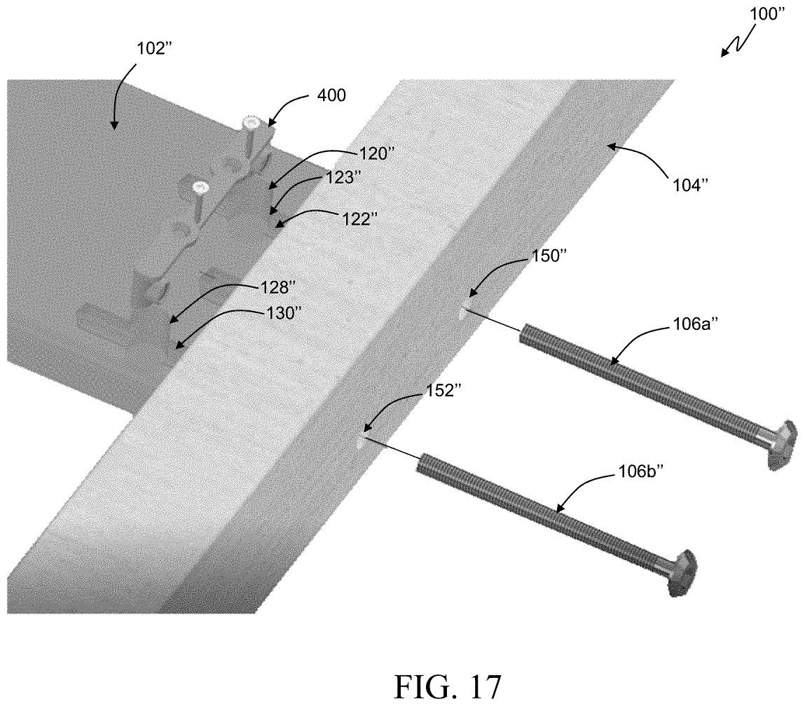

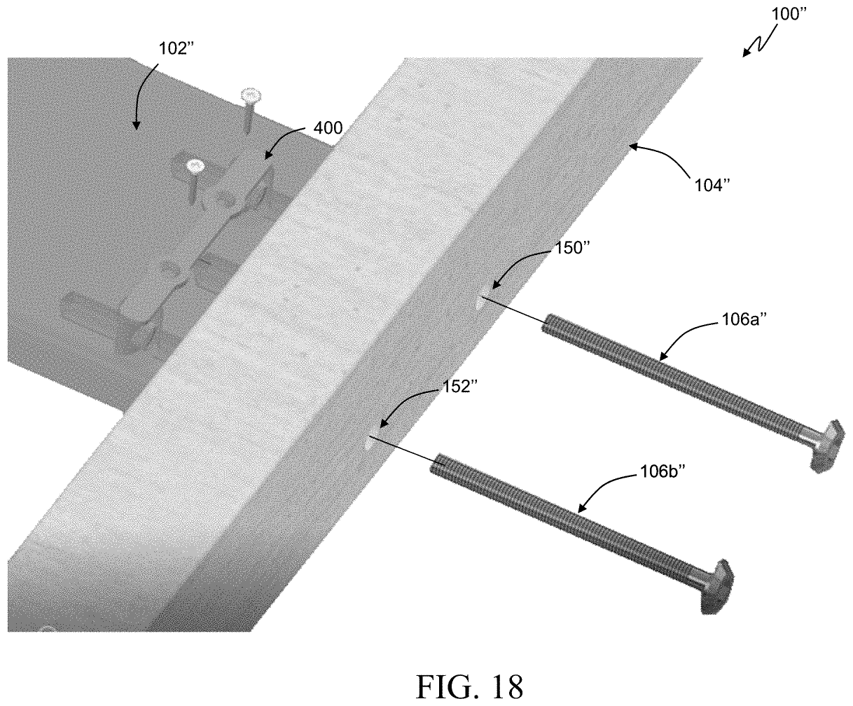

FIGS. 12 through 19 illustrate an alternate aspect of a connector 400. Portions of the embodiment disclosed in FIGS. 12 through 19 are similar to aspects described above in FIGS. 1 through 11 and those portions function similarly to those described above. The connector 400 is a multi-fastening connector that includes a body member 402, a first fastening member 404, and a second fastening member 406. The connector 400 is configured to be inserted into a first connectable part 102″ and receive first and second fastening anchors 106a″ and 106b″ within to join the first connectable part 102″ to a second connectable part 104″ (see FIGS. 17-19).

The first fastening member 404 extends from a first surface portion 408a of an inner surface 408 of the body member 402. The first fastening member 404 includes an outer fastening surface 416 that extends about the first fastening member 404. The first fastening member 404 is configured to be received within a first receiving aperture 120″ defined by the first connectable part 102″ (see FIG. 17). The first fastening member 404 includes a first fastening aperture 420 that extends through the first fastening member 404 from a first location on the outer fastening surface 416 to a second location on the outer fastening surface 416. The first fastening aperture 420 is defined by a first inner fastening surface 422 that extends about a first aperture axis L″₁ that extends through the first fastening member 404.

The first fastening member 404 further includes a first extension member 407 that extends from the outer fastening surface 416. The first extension member 407 includes a first inner extension surface 423 that extends about the first aperture axis L″₁. The first fastening aperture 420 is further defined by the first inner extension surface 423. The first fastening aperture 420 can be unthreaded, or alternatively, the first fastening aperture 420 can include a threaded portion 423′ (see e.g. FIG. 12B, connector 400′). The first extension member 407 is sized and configured to be inserted at least partially within a third receiving aperture 122″ defined by the first connectable part 102″. For example, the third receiving aperture 122″ intersects with the first receiving aperture 120″ to define an opening 123″ therebetween. When the first fastening member 404 is positioned within the first receiving aperture 120″, the first extension member 407 can be inserted into the third receiving aperture 122″ through the opening 123″.

The second fastening member 406 can be configured substantially similar to the first fastening member 404 such that portions of the second fastening member 406 function similarly to those described above with respect to the first fastening member 404. In an alternative aspect, the second fastening member 406 can be configured differently than the first fastening member 404. For example, an outer fastening surface 436 of the second fastening member 406 can either include a second extension member 409, or alternatively, the outer fastening surface 436 can be free of an extension member. In another example, the second fastening member 406 can be configured substantially similarly to the second fastening member 206 the connector 200. In another example, the second fastening member 406 can comprise an alignment member, such that the second fastening member 406 is configured substantially similarly as the alignment member 305 of the connector 300. The second fastening member 406 is configured to be positioned within the second receiving aperture 128″ of the first connectable part 102″.

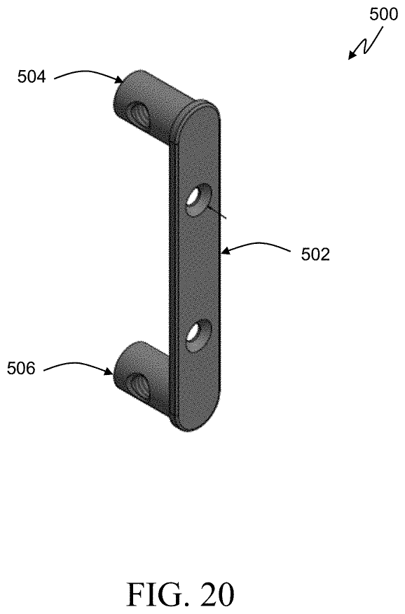

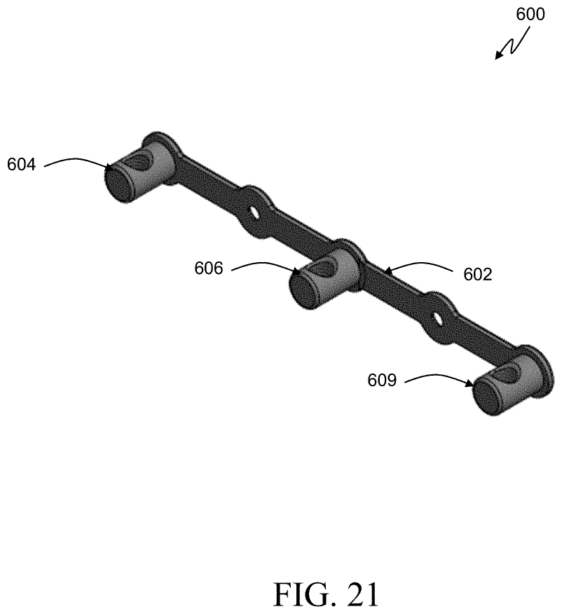

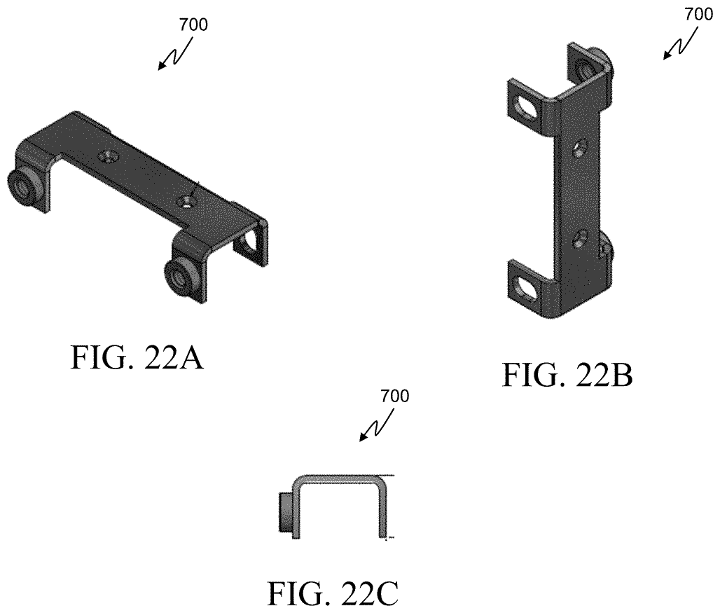

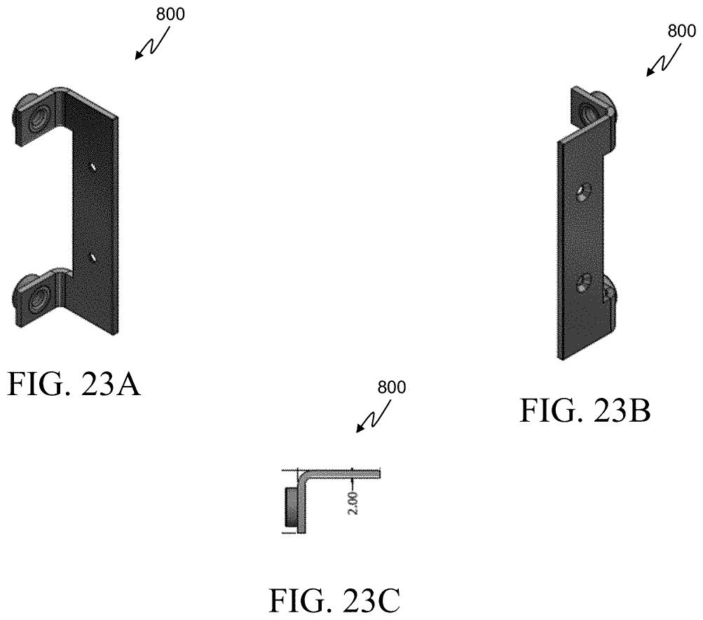

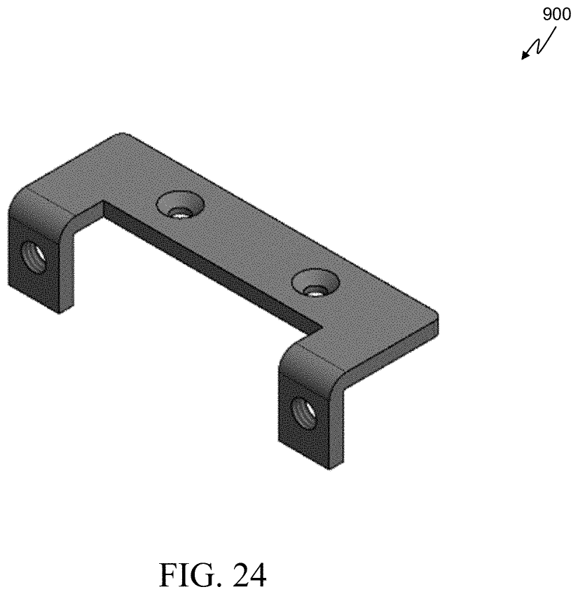

FIGS. 20 through 24 illustrate alternate aspects for a connector. FIG. 20 illustrates a multi-fastening connector 500. The connector 500 includes first and second fastening members 504 and 506 extending from a body member 502. FIG. 21 illustrates a multi-fastening connector 600. The connector 600 includes first, second, and third fastening members 604, 606, and 609 extending from a body member 602. Each of the fastening members 604, 606, and 609 can be configured substantially similarly. In an alternative aspect, the fastening members 604, 606, and 609 can be configured differently from each other. In another alternative, one or more of the fastening members 604, 606, and 609 can comprise an alignment member. FIGS. 22A through 22C illustrate a multi-fastening connector 700. FIGS. 23A through 23C illustrate a multi-fastening connector 800. FIG. 24 illustrates a multi-fastening connector 900.

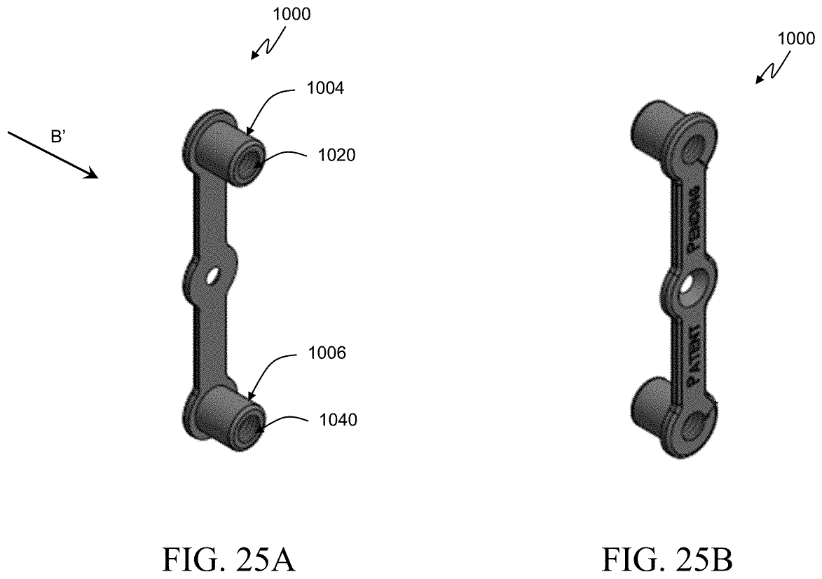

FIGS. 25 through 27 illustrate further alternate aspects for a connector. FIGS. 25A and 25B illustrate a connector 1000 with first and second fastening members 1004 and 1006. The first fastening member 1004 includes a first fastening aperture 1020 that extends through the first fastening member 1004 in a fastening direction B′. The second fastening member 1006 includes a second fastening aperture 1040 that extends through the second fastening member 1006 in the fastening direction B′. In an aspect, the first and second fastening apertures 1020 and 1040 are threaded. The fastening direction B′ of the connector 1000 can be substantially parallel to aperture axes of first and second connectable parts. For example, when first and second receiving apertures of a first connectable part are aligned with first and second receiving apertures of a second connectable part along respective first and second aperture axes, the first and second fastening members 1004 and 1006 of the connector 1000 can be inserted into the first and second receiving apertures, respectively, of the first connectable part in the fastening direction B′. The connector 1000 can be implemented, for example, in a situation in which the first connectable part 102 is rotated 90 degrees from the position illustrated in FIG. 6, such that the first outer surface 126a abuts against the second connectable part 104. The third and fourth receiving apertures 122 and 130 can be located such that they each extend from a bottom surface of the first connectable part 102 through to the first outer surface 126a. The connector 1000 can be inserted into the respective apertures 122 and 130 from the bottom surface of the first connectable part 102.

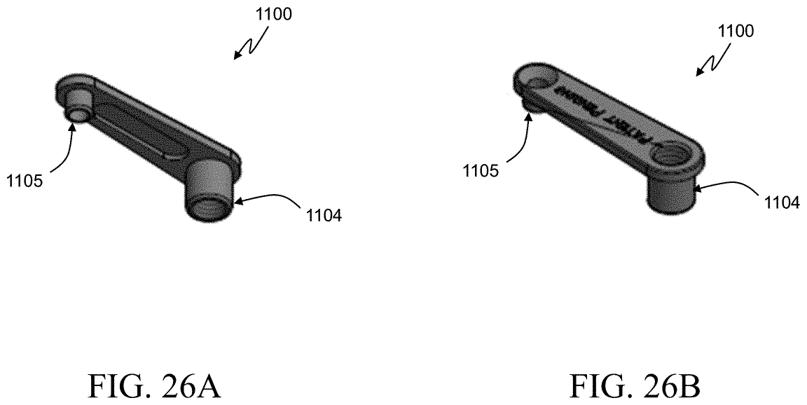

FIGS. 26A and 26B illustrate an alternate aspect of a single fastening connector 1100, according to an aspect of this disclosure. The connector 1100 includes a first fastening member 1104 and an alignment member 1105. The connector 1100 can be implemented, for example, in a situation in which the first connectable part 102′ is rotated 90 degrees from the it's position in FIG. 11, in a substantially similar manner as described herein in regard to connectors 300 and 1000.

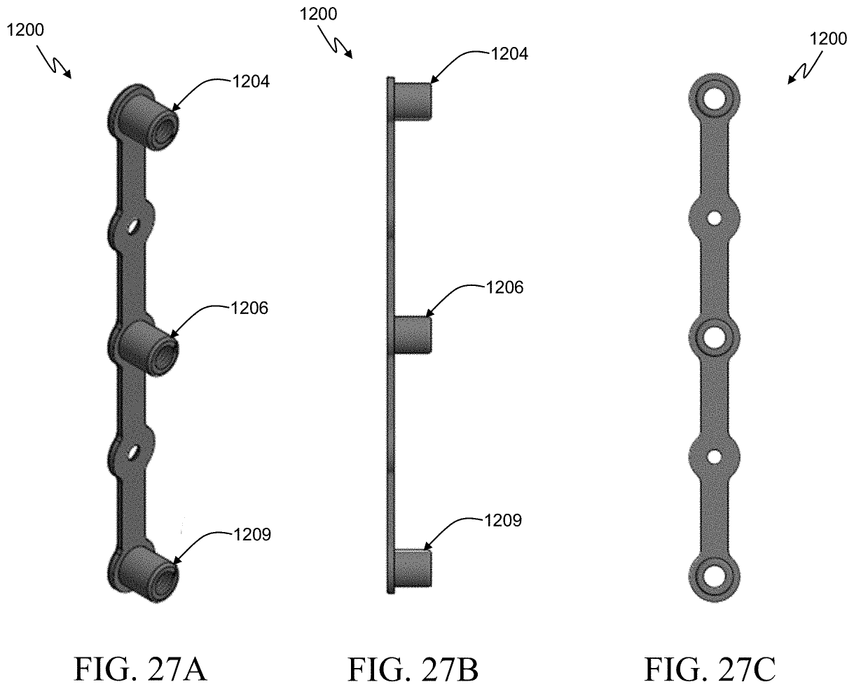

FIGS. 27A, 27B, and 27C illustrate an alternate aspect of a multi-fastening connector 1200, according to an aspect of this disclosure. The connector 1200 includes a first fastening member 1204, a second fastening member 1206, and a third fastening member 1209. The connector 1200 can be implemented, for example, in a substantially similar manner as described herein in regard to connectors 600, 1000, and 1100.

With reference to FIGS. 1 through 6, a connector system 100 can be manufactured by connecting the connector 200 to the first connectable part 102. The first fastening member 204 is inserted into the first receiving aperture 120 and the second fastening member 206 is inserted into the second receiving aperture 128. After the first and second fastening members 204 and 206 are inserted into the respective first and second receiving apertures 120 and 128, the inner surface 208 faces the outer surface 126 of the first connectable part 102. The fixation anchor 140 can be inserted through the fixation aperture 211 of the connector 200 and secured to the first connectable part 102 to secure the connector 200 to the first connectable part 102.

The first and second fastening members 204 and 206 are configured such that after inserting into the respective first and second receiving apertures 120 and 128, the first and second fastening apertures 220 and 240 of the respective first and second fastening members 204 and 206 align with the respective third and fourth receiving apertures 122 and 130 of the first connectable part 102. The alignment of the first and second fastening apertures 220 and 240 with the respective third and fourth receiving apertures 122 and 130 can be considered auto-aligning, such that when the first and second fastening members 204 and 206 are inserted into the first and receiving apertures 120 and 128, the first and second fastening apertures 220 and 240 are automatically aligned with the respective third and fourth receiving apertures 122 and 130. The first and second aperture axes L₁ and L₂ of the respective first and second fastening members 204 and 206 can be aligned and/or colinear with the respective third and fourth aperture axes L₃ and L₄ of the first connectable part 102.

The second connectable part 104 can be positioned adjacent to the first connectable part 102, such that first and second fastener apertures 150 and 152 of the second connectable part 104 align with the third and fourth receiving apertures 122 and 130 of the first connectable part 102. It will be appreciated that the second connectable part 104 can be spaced from the first connectable part 102, or alternatively, the second connectable part 104 can abut against the outer surface 126, such as the second part surface (not visible in figures) of the first connectable part 102.

After the first and second fastener apertures 150 and 152 are aligned with the respective third and fourth receiving apertures 122 and 130, the first fastening anchor 106a can be inserted through the first fastener aperture 150, through the third receiving aperture 122, and into the first fastening aperture 220 of the first fastening member 204. Similarly, the second fastening anchor 106b can be inserted through the second fastener aperture 152, through the fourth receiving aperture 130, and into the second fastening aperture 240 of the second fastening member 206. In an aspect, the first and second fastening anchors 106a and 106b can be threadedly connected to corresponding threaded portion of the respective first and second fastening members 204 and 206. Alternatively, one or both of the first and second fastening anchors 106a and 106b can extend through the respective first and second fastening apertures 220 and 240 and threadedly engage the underlying material of the first connectable part 102 to secure the first and second fastening anchors 106a and 106b to the first connectable part 102. For example, the first and second fastening anchors 106a and 106b can comprise self-tapping screws. In another alternative, the connector 200 can comprise plastic, and the first and second fastening anchors 106a and 106b can self-tap through the connector 200 or self-tap into the inner surfaces of the respective first and second fastening aperture 220 and 240.

With reference to FIGS. 7 through 11, a connector system 100′ can be manufactured by connecting the connector 300 to the first connectable part 102′. Portions of the method of manufacture described above with reference to connector 200 can be similar to the method of manufacture of the connector system 100′, and those portions can be applied to the method of manufacture of connector system 100′. The first fastening member 304 is inserted into the first receiving aperture 120′ and the alignment member 305 is inserted into the alignment aperture 121. After the first fastening member 304 and the alignment member 305 are inserted into the respective first receiving aperture 120′ and the alignment aperture 121, the inner surface 308 faces an outer surface of the first connectable part 102′. The location of the alignment aperture 121 relative to the first receiving aperture 120′ is such that when the first fastening member 304 and the alignment member 305 are positioned within the respective first receiving aperture 121′ and the alignment aperture 121 the first fastening aperture 320 aligns with the third receiving aperture 122′ of the first connectable part 102′. After insertion of the fastening member 304 and the alignment member 305 within the respective first receiving aperture 121′ and the alignment aperture 121, the first aperture axis L′₁ of the first fastening members 304 can be aligned and/or colinear with the respective third aperture axis L′₃ of the first connectable part 102′.

As explained above with reference to the second connectable part 104, the second connectable part 104′ can be positioned adjacent to the first connectable part 102′, such that a first fastener aperture (not visible in figures) of the second connectable part 104′ aligns with the third receiving aperture 122′ of the first connectable part 102′.

After the first fastener aperture of the second connectable part 104′ is aligned with the third receiving aperture 122′, the first fastening anchor 106′ can be inserted through the first fastener aperture, through the third receiving aperture 122′, and into the first fastening aperture 320 of the first fastening member 304 to secure the second connectable part 104′ to the first connectable part 102′.

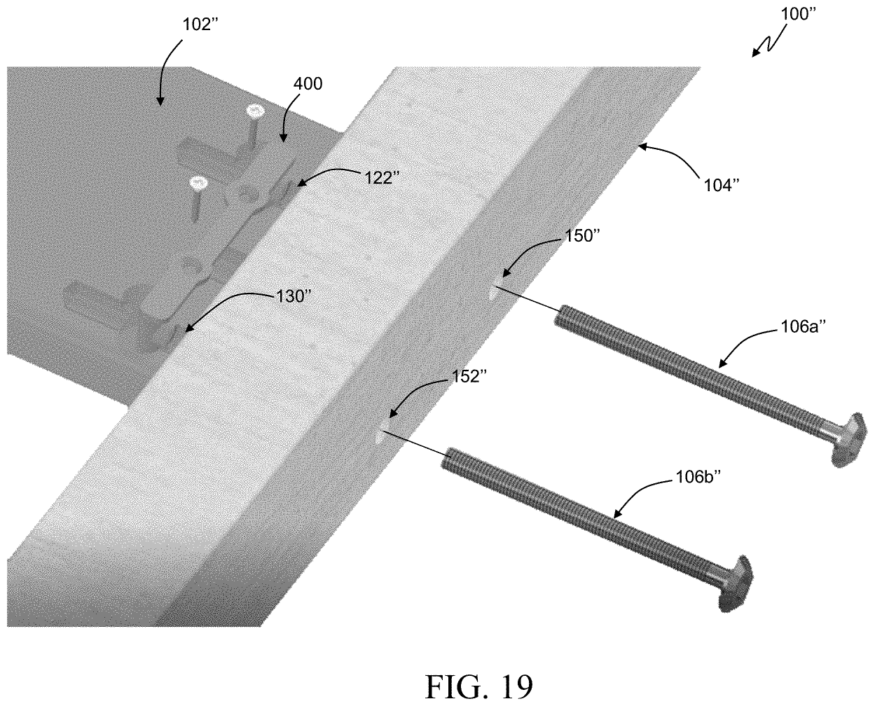

With reference to FIGS. 12 through 19, a connector system 100″ can be manufactured by connecting the connector 400 to the first connectable part 102″. Portions of the method of manufacture described above with reference to connectors 200 and 300 can be similar to the method of manufacture of the connector system 100″, and those portions can be applied to the method of manufacture of connector system 100″. The first fastening member 404 is inserted into the first receiving aperture 120″ and the second fastening member 406 is inserted into the second receiving aperture 128″. After the first and second fastening members 404 and 406 are inserted into the respective first and second receiving apertures 120″ and 128″, the first extension member 407 can be inserted into the third receiving aperture 122″ through the opening 123″ (see FIG. 19). Similarly, the second extension member 409 can be inserted into a fourth receiving aperture 130″ through an opening defined between the second receiving aperture 128″ and the fourth receiving aperture 130″. Insertion of the first and second extension members 407 and 409 into the respective third and fourth receiving apertures 122″ and 130″ can help align the first and second fastening apertures 420 and 440 with the respective third and fourth receiving apertures 122″ and 130″. The first and second extension members 407 and 409 can also help retain the first and second fastening members 404 and 406 within the respective first and second receiving apertures 120″ and 128″.

As explained above with reference to the second connectable part 104, the second connectable part 104″ can be positioned adjacent to the first connectable part 102″, such that a first fastener aperture 150″ of the second connectable part 104″ aligns with the third receiving aperture 122″ of the first connectable part 102′, and a second fastener aperture 152″ of the second connectable part 104″ aligns with the fourth receiving aperture 130″.

After the first and second fastener apertures 150″ and 152″ of the second connectable part 104″ are aligned with the respective third and fourth receiving aperture 122″ and 130″, the first and second fastening anchors 106a″ and 106b″ can be inserted through the respective first and second fastener apertures 150″ and 152″, through the respective third and fourth receiving apertures 122″ and 130″, and into the respective first and second fastening aperture 420 and 440 of the respective first and second fastening member 404 and 406 to secure the second connectable part 104″ to the first connectable part 102″.

Although reference was made to the connectors 200, 300, and 400 in the above described examples for using the connectors 200, 300, and 400, similar methods may also be employed to use the connectors 500, 600, 700, and 800.

It will be appreciated that the foregoing description provides examples of the disclosed system and method. However, it is contemplated that other implementations of the disclosure may differ in detail from the foregoing examples. For example, any of the embodiments disclosed herein can incorporate features disclosed with respect to any of the other embodiments disclosed herein. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

As one of ordinary skill in the art will readily appreciate from that processes, machines, manufacture, composition of matter, means, methods, or steps, presently existing or later to be developed that perform substantially the same function or achieve substantially the same result as the corresponding embodiments described herein may be utilized according to the present disclosure.

What is claimed is:

1. A connector comprising:
a body member having an inner surface configured to face an underlying connectable part, the inner surface having a first surface portion and a second surface portion, wherein the first surface portion extends from a first end of the body member to the second surface portion, and wherein the second surface portion extends from the first surface portion to a second end of the body member that is spaced from the first end of the body member;
a fastening member that extends from the first surface portion, wherein the fastening member includes a fastening aperture that extends through the fastening member and is configured to receive a fastening anchor; and
an alignment member extending from the second surface portion and spaced from the fastening member along the surface of the body member.

2. The connector of claim 1, wherein the fastening member includes an outer fastening surface, wherein the outer fastening surface is substantially perpendicular to the first surface portion.

3. The connector of claim 1, wherein the alignment member includes an outer alignment surface, wherein the outer alignment surface is substantially perpendicular to the second surface portion.

4. The connector of claim 1, wherein the first surface portion is angularly offset from the second surface portion.

5. The connector of claim 4, wherein the first surface portion extends from the first end of the body member to a location at a center of the body member.

6. The connector of claim 1, wherein the fastening aperture is a first fastening aperture, and wherein the fastening anchor is a first fastening anchor, wherein the alignment member includes a second fastening aperture that extends through the alignment member and is configured to receive a second fastening anchor.

7. The connector of claim 1, wherein the connector further comprises:
a plurality of fastening members, wherein the fastening member is a first fastening member of the plurality of fastening members, and wherein the fastening aperture is a first fastening aperture, wherein each of the plurality of fastening members extend from at least one of the first surface portion and the second surface portion of the body member, and wherein each one of the plurality of fastening members includes a second fastening aperture that extends through the respective fastening member and is configured to receive a second fastening anchor.

8. The connector of claim 1, wherein the fastening aperture extends through the fastening member about an aperture axis, wherein the aperture axis is substantially perpendicular to the first surface portion.

9. The connector of claim 1, wherein the body member has an outer surface that opposes the inner surface, wherein the body member includes a fixation aperture that extends through the body member from the outer surface to the inner surface and is configured to receive a fixation anchor therein.

10. The connector of claim 1, wherein the fastening member includes an outer fastening surface and an extension member, wherein the extension member extends from the outer fastening surface, wherein the fastening aperture further extends through the extension member.

11. A connector system comprising:
a connectable part having a part surface that defines a first receiving aperture and a second receiving aperture spaced from the first receiving aperture, the first and second receiving apertures extending at least partially through the connectable part; and
a connector comprising,
a connector body having an inner surface configured to face the part surface of the connectable part, the inner surface having a first surface portion and a second surface portion adjacent to the first surface portion,
a fastening member that extends from the first surface portion, wherein the fastening member includes a fastening aperture that extends through the fastening member and is configured to receive a fastening anchor, the fastening member being positionable within the first receiving aperture of the connectable part, and
an alignment member extending from the second surface portion and spaced from the fastening member along the surface of the connector body, the alignment member being positionable within the second receiving aperture of the connectable part.

12. The connector system of claim 11, wherein the part surface is a first part surface, wherein the connectable part further has a second part surface, the second part surface defining a third receiving aperture extending at least partially through the connectable part and intersecting with the first receiving aperture,
wherein the fastening aperture of the fastening member extends about a first aperture axis, and wherein the third receiving aperture of the connectable part extends about a third aperture axis, wherein when the fastening member is positioned within the first receiving aperture, the first aperture axis of the fastening aperture substantially aligns with the third aperture axis of the third receiving aperture.

13. The connector system of claim 12, further comprising:
the fastening anchor configured to be positioned within the third receiving aperture of the connectable part and the fastening aperture of the fastening member when the fastening member is positioned within the first receiving aperture of the connectable part.

14. The connector system of claim 13, wherein the fastening aperture is defined by an inner fastening surface of the fastening member, wherein the inner fastening surface includes an internal threaded portion, and wherein an outer surface of the fastening anchor defines an external threaded portion that is configured to threadedly engage the internal threaded portion of the fastening aperture.

15. The connector system of claim 12, wherein the fastening aperture is a first fastening aperture, wherein the alignment member includes a second fastening aperture that extends through the alignment member and is configured to receive a second fastening anchor,
wherein the second part surface further defines a fourth receiving aperture extending at least partially through the connectable part and intersecting with the second receiving aperture,
wherein the second fastening aperture of the alignment member extends about a second aperture axis, and wherein the fourth receiving aperture of the connectable part extends about a fourth aperture axis, wherein when the alignment member is positioned within the second receiving aperture, the second aperture axis of the second fastening aperture substantially aligns with the fourth aperture axis of the fourth receiving aperture.

16. The connector system of claim 12, wherein the fastening member includes an outer fastening surface and an extension member, wherein the extension member extends from the outer fastening surface, wherein the fastening aperture further extends through the extension member, and
wherein the first receiving aperture and the third receiving aperture intersect to define an opening therebetween within the connectable part, wherein when the fastening member is positioned within the first receiving aperture, the extension member is positionable through the opening and into the third receiving aperture.

17. A method of manufacturing the connector system recited in claim 11, the method comprising:
inserting the fastening member into the first receiving aperture of the connectable part, wherein the fastening aperture opens to a third receiving aperture defined by the connectable part, the third receiving aperture extending at least partially through the connectable part and intersecting with the first receiving aperture; and
inserting the alignment member within the second receiving aperture of the connectable part,
wherein after the steps of inserting the fastening member and inserting the alignment member the inner surface of the connector body faces the part surface of the connectable part.

18. The method of claim 17, wherein the body member has an outer surface that opposes the inner surface, and wherein the body member includes at least one fixation aperture that extends through the body member from the outer surface to the inner surface, the method further comprising:
inserting at least one fixation anchor through the at least one fixation aperture.

19. The method of claim 17, wherein the fastening member includes an outer fastening surface and an extension member that extends from the outer fastening surface, wherein the fastening aperture further extends through the extension member, and wherein the first receiving aperture and the third receiving aperture intersect to define an opening therebetween within the connectable part, the method further comprising
inserting the extension member through the opening and into the third receiving aperture.

20. The method of claim 17, wherein the connectable part is a first connectable part, the method further comprising:
inserting a fastening anchor through the third receiving aperture of the first connectable part and into the first receiving aperture to secure a second connectable part to the first connectable part.
